(19) United States
(12) Patent Application Publication
(10) Pub. No.: US 2026/0239504 A1
(43) Pub. Date: Aug. 13, 2026

(54) AEROSOL GENERATION APPARATUS AND CONTROL METHOD THEREFOR

(71) Applicant: SHENZHEN FIRST UNION TECHNOLOGY CO., LTD., Shenzhen, Guangdong (CN)

(72) Inventors: Xinjun LI, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 19/155,095

(22) PCT Filed: Jan. 10, 2024
(86) PCT No.: PCT/CN2024/071653

§ 371 Date: Aug. 8, 2025

(30) Foreign Application Priority Data
Feb. 9, 2023 (CN) 202310143323.5

(51) Int. Cl. H05B 45/22; A24F 40/51; A24F 40/53; H05B 1/02; H05B 45/10; H05B 45/345; H05B 47/105

(52) U.S. Cl. CPC H05B 45/22; A24F 40/51; A24F 40/53; H05B 1/0252; H05B 45/10; H05B 45/345; H05B 47/105

(57) ABSTRACT

An aerosol generation apparatus and a control method therefor are provided. The method includes: in a light source calibration stage, outputting initial driving current, driving a light source based on the initial driving current, determining a color value corresponding to a color label under illumination of the light source, and determining the initial driving current as calibration current if the color value satisfies a preset standard color value; and in a recognition stage for an aerosol generation product, driving the light source based on the calibration current, determining a color value corresponding to the color label under the illumination of the light source, and determining at least one of a type, an insertion state, or a disengagement state of the aerosol generation product based on the color value.

### CROSS-REFERENCE TO RELATED APPLICATIONS

This application claims priority to Chinese Patent Application No. 202310143323.5, filed with the China National Intellectual Property Administration on Feb. 9, 2023 and entitled “AEROSOL GENERATION APPARATUS AND CONTROL METHOD THEREFOR”, which is incorporated herein by reference in its entirety.

### TECHNICAL FIELD

The present application relates to the field of aerosol generation, and in particular to, an aerosol generation apparatus and a control method therefor.

### BACKGROUND

An aerosol generation apparatus releases a compound by heating an aerosol generation product. Usually, after the aerosol generation product is inserted, heating on the aerosol generation product is started by an input element such as a button.

Certainly, a dedicated sensor is separately provided to detect the insertion of the aerosol generation product, to automatically start the heating on the aerosol generation product. Currently, commonly used sensors include an infrared sensor, a pressure sensor, or the like. A color sensor is also arranged in the aerosol generation apparatus. The color sensor can accurately and timely determine an insertion state of the aerosol generation product by recognizing a color label in the aerosol generation product under a particular light source condition, and heating on the aerosol generation product can be automatically started based on the insertion state of the aerosol generation product.

In a light source solution, the existing color sensor employs voltage to drive a light source. When the voltage fluctuates, stability and consistent of the light source cannot be ensured. If the light source is unstable and inconsistent, color value recognition will not be accurate during the recognition performed by the color sensor on the color label in the aerosol generation product.

### SUMMARY

Embodiments of the present application provide an aerosol generation apparatus and a control method therefor, which solve the problem of inaccurate color recognition on an aerosol generation product due to instability and inconsistency of a light source.

According to an aspect of the embodiments of the present application, an aerosol generation apparatus is provided, including: an aerosol heating element, configured to heat an aerosol generation product to generate an aerosol; a color sensor, configured to detect a color value of a color label; a light source, configured to provide illumination during detection of the color label by the color sensor; a power supply; and a processor, configured to: in a light source calibration stage, adjust driving current of the light source, determine a color value corresponding to the color label under the illumination of the light source that is subjected to each adjustment, and determine corresponding driving current as calibration current until the color value satisfies a preset standard color value, where the color label is arranged inside a calibration fixture and/or the aerosol generation product, the processor being further configured to: in a recognition stage for the aerosol generation product, drive the light source based on the calibration current; determine, under the illumination of the light source, a color value corresponding to the color label arranged inside the aerosol generation product; and determine at least one of a type, an insertion state, or a disengagement state of the aerosol generation product based on the color value, where the color label is arranged inside the aerosol generation product.

In some embodiments, the aerosol generation apparatus further includes a light source driving circuit; the light source driving circuit includes a constant-current driver chip, and the constant-current driver chip is respectively connected to the light source, the power supply, and the processor; and the constant-current driver chip is configured to: adjust, based on a control signal output by the processor, the driving current and output the driving current to the light source.

In some embodiments, the light source includes at least two light-emitting diodes (LEDs).

In some embodiments, the constant-current driver chip includes a clock signal input end and a data signal input end; and the clock signal input end and the data signal input end are configured to receive the control signal transmitted by the processor through an inter-integrated circuit (IIC) bus, to control the driving current output by the constant-current driver chip.

In some embodiments, the constant-current driver chip further includes at least two driving current output ends, and the at least two driving current output ends are respectively connected to the at least two LEDs to drive the at least two LEDs.

According to another aspect of the embodiments of the present application, a control method for an aerosol generation apparatus is provided. The aerosol generation apparatus includes an aerosol generation heating element, a light source, and a color sensor; the color sensor is configured to detect a color value of a color label in a case that the light source provides illumination; and the method includes: in a light source calibration stage, outputting initial driving current; driving the light source based on the initial driving current, and determining a color value corresponding to the color label under the illumination of the light source, where the color label is arranged inside a calibration fixture or an aerosol generation product; if the color value satisfies a preset standard color value, determining the initial driving current as calibration current; in a recognition stage for the aerosol generation product, driving the light source based on the calibration current, and determining a color value corresponding to the color label under the illumination of the light source, where the color label is arranged inside the aerosol generation product inserted into the aerosol generation apparatus; and determining at least one of a type, an insertion state, or a disengagement state of the aerosol generation product based on the color value.

In some embodiments, in the light source calibration stage, the method further includes: if the color value does not satisfy the preset standard color value, adjusting the initial driving current at least once; and driving the light source based on the adjusted driving current, determining a color value corresponding to the color label under the illumination of the light source, and determining the last adjusted driving current as the calibration current until the color value satisfies the preset standard color value.

In some embodiments, before the light source calibration stage, the method includes: initiating the light source calibration stage based on at least one of the following conditions: each time a user turns on the light source, reaching a preset number of instances of turning on, and reaching preset working duration of the light source.

In some embodiments, in the light source calibration stage, the outputting initial driving current includes: outputting the initial driving current based on preset initial driving current or based on driving current obtained after calibration current determined in a previous light source calibration stage changes based on a preset increment rule.

According to still another aspect of the embodiments of the present application, a control method for an aerosol generation apparatus is provided. The aerosol generation apparatus includes an aerosol generation heating element, a light source, and a color sensor; the color sensor is configured to detect a color value of a color label in a case that the light source provides illumination; and the method includes: in a light source calibration stage, adjusting the driving current of the light source at least once; after each adjustment, determining a color value corresponding to the color label, determining whether the color value satisfies a preset standard color value, and determining corresponding driving current as calibration current until the color value satisfies the preset standard color value; in a recognition stage for an aerosol generation product, driving the light source based on the calibration current; and under the illumination of the calibrated light source, determining a color value corresponding to the color label arranged inside the aerosol generation product, and determining at least one of a type, an insertion state, or a disengagement state of the aerosol generation product based on the color value.

The embodiments of the present application provide an aerosol generation apparatus and a control method therefor. Elements and steps that are used for calibrating a light source are added in an application process of a color sensor, to implement light source calibration. In a light source calibration stage, a color value of a color label detected by the color sensor under illumination of the light source is compared with a preset standard color value. If the detected color value is equal to the preset standard color value, initial driving current of the light source is calibration current. If the detected color value is not the preset standard color value, a control signal is output to continuously adjust the driving current of the light source, and corresponding light source driving current is determined as calibration current until the detected color value of the color label is the preset standard color value. The light source is driven based on the calibration current to calibrate the light source. The embodiments of the present application implement light source calibration by adding elements and steps that are used for calibrating the light source, so that consistency and stability of the light source are improved. The color sensor recognizes the aerosol generation product under a condition of a calibrated light source, which is favorable for improving recognition accuracy.

### BRIEF DESCRIPTION OF THE DRAWINGS

One or more embodiments are exemplarily described with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic structural diagram of an aerosol generation apparatus according to an embodiment of the present application;

FIG. 2 is a schematic structural diagram of a light source driving circuit according to an embodiment of the present application;

FIG. 3 is a circuit structural diagram of the light source driving circuit in FIG. 2;

FIG. 4 is a flowchart of a control method for an aerosol generation apparatus according to an embodiment of the present application; and FIG. 5 is another flowchart of a control method for an aerosol generation apparatus according to an embodiment of the present application.

### DETAILED DESCRIPTION

To make the objectives, technical solutions, and advantages of the present application clearer, the following further describes the present application in detail with reference to the accompanying drawings and the embodiments. It should be understood that the specific embodiments described here are only intended to explain the present application and are not intended to limit the present application.

It should be noted that, the features in the embodiments of the present application may be combined with each other without conflicts, and all fall within the protection scope of the present application. In addition, division of functional modules has been shown in a schematic diagram of an apparatus, and a logical order is shown in the flowchart. In some cases, the steps shown or described can be executed in an order different from the module division in the schematic diagram of the apparatus or the order in the flowchart.

Unless otherwise defined, meanings of all technical and scientific terms used in this specification are the same as those usually understood by a person skilled in the technical field to which the present application belongs. Terms used in the specification of the present application are merely intended to describe objectives of the specific implementations, but are not intended to limit the present application.

A color sensor is arranged in an aerosol generation apparatus. The color sensor is used to recognize an inserted aerosol generation product under a light source condition and transmit a detection result to the processor to accurately and timely determine a type and/or a position of the aerosol generation product. The processor can automatically initiate different heating modes for the aerosol generation product based on the type of the aerosol generation product, and can also automatically start heating on the aerosol generation product based on the position of the aerosol generation product. A light source provides illumination for the color sensor to recognize the product. Therefore, the light source is an important factor affecting the accuracy of product color recognition performed by the color sensor.

At present, in a light source solution of the color sensor, the color sensor usually employs a high-brightness white LED as the light source, and the luminous intensity of the white LED is determined by driving current. Constant voltage is currently used to drive the LED, and the brightness can be freely adjusted by using a pulse width modulation (PWM) form. When voltage at two ends of the LED fluctuates, the driving current will fluctuate proportionally, causing significant changes in brightness and a decrease in luminous quality of the LED. As a result, the LED has unstable brightness. When the light source is composed of a plurality of LEDs, if voltage is used to drive the LEDs, consistency of brightness of the LEDs cannot be ensured because of a different in current. In addition, using voltage to drive the LED, because the rated current cannot be exceeded, may also affect the reliability of working of the LEDs. Differences in the light source can easily lead to inaccurate color recognition performed by the color sensor on the product, so the light source needs to be calibrated.

Therefore, in the embodiments of the present application, a constant-current driver chip is added into the aerosol generation apparatus to implement calibration of the light source. Using constant current to drive the LEDs avoids the impact on the reliability of the LEDs because of driving current exceeding a rated range on the reliability of the LED, and also ensures stability and consistency of the light source. Under a calibrated light source condition, it is beneficial for improving the recognition accuracy of the color sensor on the product.

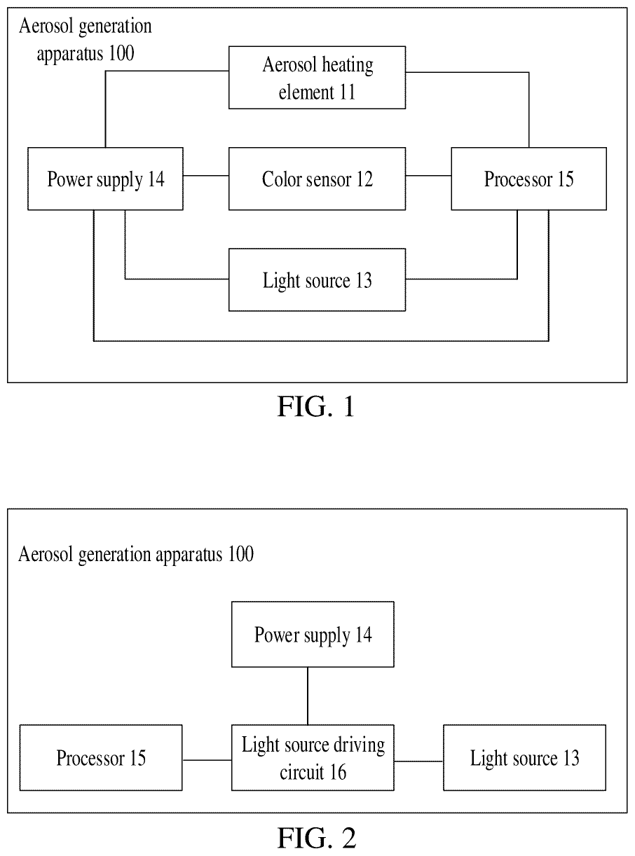

Referring to FIG. 1, FIG. 1 is a schematic structural diagram of an aerosol generation apparatus according to this embodiment. As shown in FIG. 1, the aerosol generation apparatus 100 includes an aerosol heating element 11, a color sensor 12, a light source 13, a power supply 14, and a processor 15. The processor 15 is connected to the aerosol heating element 11, the color sensor 12, the light source 13, and the power supply 14 respectively. The power supply 14 is further connected to the aerosol heating element 11, the color sensor 12, and the light source 13.

The aerosol heating element 11 is configured to heat an aerosol generation product to generate an aerosol. An existing aerosol generation product usually includes filter tip section and a tobacco section. When a user inserts the aerosol generation product into the aerosol generation apparatus, the aerosol generation apparatus heats an aerosol forming substrate contained in the tobacco section in the aerosol generation product to generate an aerosol inhaled by the user. In some embodiments, the aerosol generation product may alternatively include a liquid or oily aerosol forming substrate.

The color sensor 12 is configured to detect a color value of a color label. The color value is specifically an RGB color value, where R, G, and B respectively represent three primary colors of light. Any color of red, green, and blue has 256 different display levels, namely relative brightness of the three primary colors: red, green, and blue, specifically 0 to 255. Each color has a minimum value of 0 and a maximum value of 255. All colors in a natural world can be synthesized through various combinations of different levels of the three primary colors. For example, if the color values of the three primary colors: red, green, and blue are equal, and their display levels are all at their maximum values, a combined color is white with a color value of (255, 255, 255). If the display levels of the three primary colors: red, green, and blue, are all at their minimum values, a combined color is black with a color value of (0,0,0). If the display levels of red and green are at the maximum values and the display level of blue is at the minimum value, a combined color is yellow with a color value of (255, 255, 0). The color label is arranged inside the aerosol generation product, and the color label may be in a single color, for example: red, or may be a mixed color. Different colors may represent different flavors of different aerosol generation products. For example: Red represents a strawberry-flavored aerosol generation product, yellow represents a mango-flavored aerosol generation product, and the like.

The light source 13 is configured to provide illumination during detection of the color label by the color sensor. The light source 13 includes at least two LEDs. Since working current of a single LED cannot exceed a preset current threshold, a brightness requirement during the detection performed by the color sensor on the color label may not be met. Typically, two LEDs are sufficient to meet the brightness requirement. Therefore, a quantity of LEDs is set to at least two. The at least two LEDs jointly provide illumination for the color sensor to detect the color label. The preset current threshold is related to a model number of the LED and is not specifically limited in the present application.

The power supply 14 is configured to supply power to components in the aerosol generation apparatus. For example: the power supply 14 supplies power to the aerosol heating element 11 to heat the aerosol generation product inserted in place. The power supply 14 supplies power to the processor 15 to implement overall control on the aerosol generation apparatus 100. That is, the processor 15 controls operations of elements in the aerosol generation apparatus 100.

The processor 15 is configured to: in a light source calibration stage, adjust driving current of the light source, determine a color value corresponding to the color label under the illumination of the light source that is subjected to each adjustment, and determine corresponding driving current as calibration current until the color value satisfies a preset standard color value, where the color label is arranged inside a calibration fixture and/or the aerosol generation product. The processor is further configured to: in a recognition stage for the aerosol generation product, drive the light source based on the calibration current; determine, under the illumination of the light source, a color value corresponding to the color label arranged inside the aerosol generation product; and determine at least one of a type, an insertion state, or a disengagement state of the aerosol generation product based on the color value, where the color label is arranged inside the aerosol generation product.

In some embodiments, the aerosol generation product specifically includes a filter tip section and a tobacco section. The color label is arranged on an outer surface of the filter tip section at a junction with the tobacco section. It should be noted that to facilitate detection and recognition by the color sensor, a color of the color label is different from a color of the outer surface of the tobacco section. The standard color value is set according to an actual situation. This embodiment of the present application does not specifically limit it. In some embodiments, the standard color value may be within a standard color range, that is, the color value recognized by the color sensor is within a preset standard color range. The type of the aerosol generation product may specifically represent a flavor of the aerosol generation product. The color sensor may recognize the color label arranged inside the aerosol generation product and obtain a corresponding color value. After obtaining the color value, the processor compares the color value with stored standard color values of flavors, to determine the type of the aerosol generation product. For different types of aerosol generation products, different heating modes, namely, different heating temperatures, are employed based on pre-stored temperature configuration information, to make a user obtain the best flavor. For example: A mango-flavored aerosol generation product is heated in a heating model at 300° C., while a strawberry-flavored aerosol generation product is heated in a heating mode at 310° C. The insertion state indicates a process of inserting the aerosol generation product into the aerosol generation apparatus 100 or indicates that a position of the aerosol generation product inserted into the aerosol generation apparatus 100 has been in place. In the process of inserting the aerosol generation product into the aerosol generation apparatus 100, whether an insertion position is in place is continuously recognized. Only when the position of the aerosol generation product inserted into the aerosol generation apparatus 100 is in place, the processor 15 controls the aerosol heating element 11 to automatically start heating. When the color sensor sequentially detects the color of the outer surface of the tobacco section and the color of the color label, it indicates that the position of the aerosol generation product inserted into the aerosol generation apparatus 100 is in place. The disengagement state indicates that the position of the aerosol generation product inserted into the aerosol generation apparatus 100 is deviated or the aerosol generation product has been pulled out of the aerosol generation apparatus 100. In this case, the processor 15 controls the aerosol heating element 11 to stop heating. In some embodiments, the processor may recognize a combination of two of the type, the insertion state, and the disengagement state of the product, such as, recognizing the type and insertion state of the product; and recognize the insertion state and the disengagement state. Or, the processor may recognize a combination of the type, the insertion state, and the disengagement state, such as, recognizing the type, the insertion state, and the disengagement state.

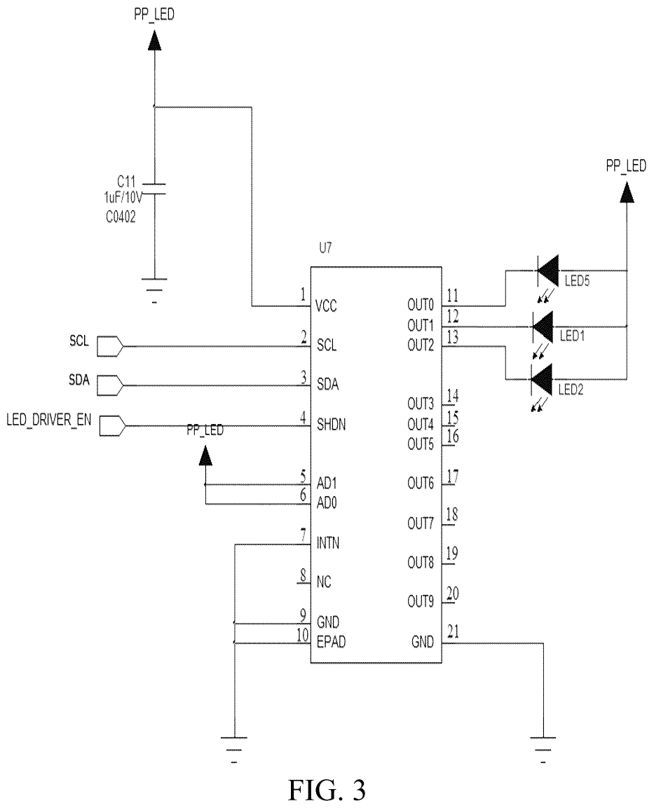

In this embodiment of the present disclosure, a light source driving circuit 16 is added into the aerosol generation apparatus 100 to calibrate the light source 13. Referring to FIG. 2, FIG. 2 is a schematic structural diagram of a light source driving circuit according to an embodiment of the present application. The constant-current driver chip is respectively connected to the light source 13, the power supply 14, and the processor 15. The power supply 14 is configured to supply power to the constant-current driver chip and the light source 13. The constant-current driver chip is configured to: adjust, based on a control signal output by the processor 15, the driving current and output the driving current to the light source 13.

The constant-current driver chip includes a clock signal input end and a data signal input end. The clock signal input end and the data signal input end are configured to receive the control signal transmitted by the processor 15 through an IIC bus, and the control signal includes a clock signal and a data signal, to control the constant-current driver chip to output the driving current. The constant-current driver chip further includes at least two driving current output ends, and the at least two driving current output ends are respectively connected to the at least two LEDs to drive the at least two LEDs.

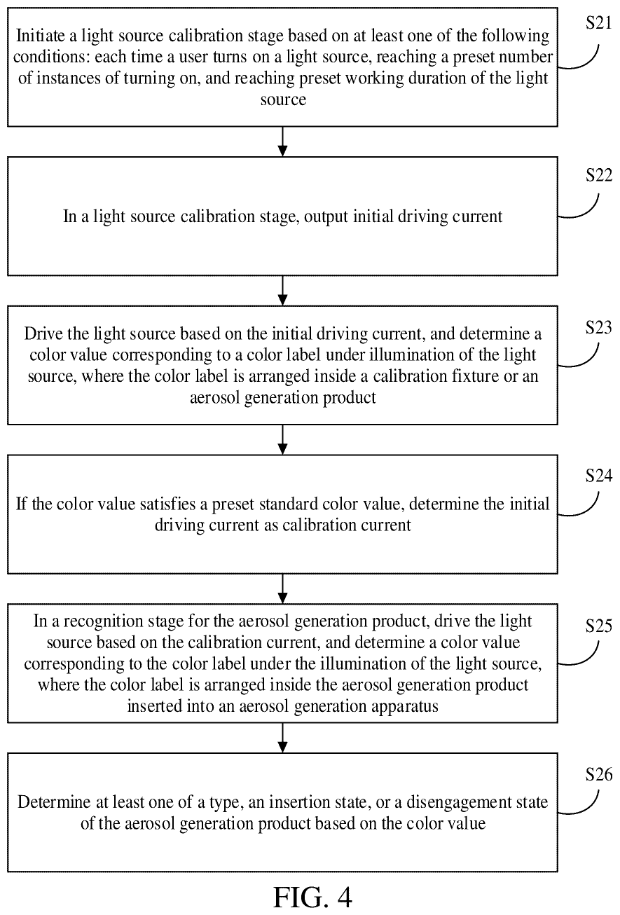

Specifically, referring to FIG. 3, FIG. 3 is a circuit structural diagram of the light source driving circuit in FIG. 2. As shown in FIG. 3, the light source driving circuit 16 includes a driver chip U7 and a capacitor C11. A model number of the constant-current driver chip may be specifically AW9110B, which is a 10-channel constant-current driver chip. It has 10 independent output ports (OUT0 to OUT9) and may drive up to 10 LEDs. The constant-current driving chip U7 is configured to: adjust, based on a control signal output by the processor 15, the driving current and output the driving current to the light source 13. The capacitor C11 may improve stability of the light source driving circuit 16 during operation.

A first end of the driver chip U7, a fifth end of the driver chip U7, and a sixth end of the driver chip U7 are all connected to the power supply 14. A second end of the driver chip U7, a third end of the driver chip U7, and a fourth end of the driver chip U7 are all connected to the processor 15. A seventh end of the driver chip U7, a ninth end of the driver chip U7, a tenth end of the driver chip U7, and a twenty-first end of the driver chip U7 are all grounded. An eleventh end of the driver chip U7, a twelfth end of the driver chip U7, and a thirteenth end of the driver chip U7 are connected to the light source 13. The light source 13 is further connected to the power supply 14. A first end of the capacitor C11 is connected to the power supply 14, and a second end of the capacitor C11 is grounded.

The light source 13 includes: an LED1, an LED2, and an LED5. A negative electrode of the LED1 is connected to the twelfth end of the driver chip U7. A negative electrode of the LED2 is connected to the thirteenth end of the driver chip U7. A negative electrode of the LED5 is connected to the tenth end of the driver chip U7. A positive electrode of the LED1, a positive electrode of the LED2, and a positive electrode of the LED5 are all connected to the power supply 14.

Specifically, a fourth end of the constant-current driver chip U7 is an enable end. If the fourth end is not activated, the constant-current driver chip U7 will have no output. A second end of the constant-current driver chip U7 is a clock signal input end which may receive the clock signal transmitted by processor 15. A third end of the constant-current driver chip U7 is a data signal input end which can receive the data signal transmitted by processor 15. The fifth end and the sixth end of the constant-current driver chip U7 are address setting ends which match an address of the processor 15 to implement communication. Constant current output by the eleventh end of the constant-current driver chip U7 drives the LED5. Constant current output by the twelfth end of the constant-current driver chip U7 drives the LED1. Constant current output by the thirteenth end of the constant-current driver chip U7 drives the LED2. In some embodiments, the constant-current driver chip may be connected to the processor based on a communication protocol such as a serial port and a universal serial bus (USB). The light source 13 may include another quantity of LEDs, as long as the quantity of LEDs is greater than or equal to two and does not exceed a quantity of channels of the constant-current driver chip. For example, if the constant-current driver chip includes five channels, the light source 13 may specifically include four LEDs.

In this embodiment of the present application, the light source driving circuit is added into the aerosol generation apparatus, and the light source driving circuit includes the constant-current driver chip, thus implementing that the constant current drives the LEDs in the light source. The processor compares the color value of the color label detected by the color sensor with the preset standard color value, obtains the calibration current, and then completes calibration on the light source based on the calibration current, thereby improving consistency and stability of the light source. Since the color sensor recognizes the product under the calibrated light source condition, the recognition accuracy is improved.

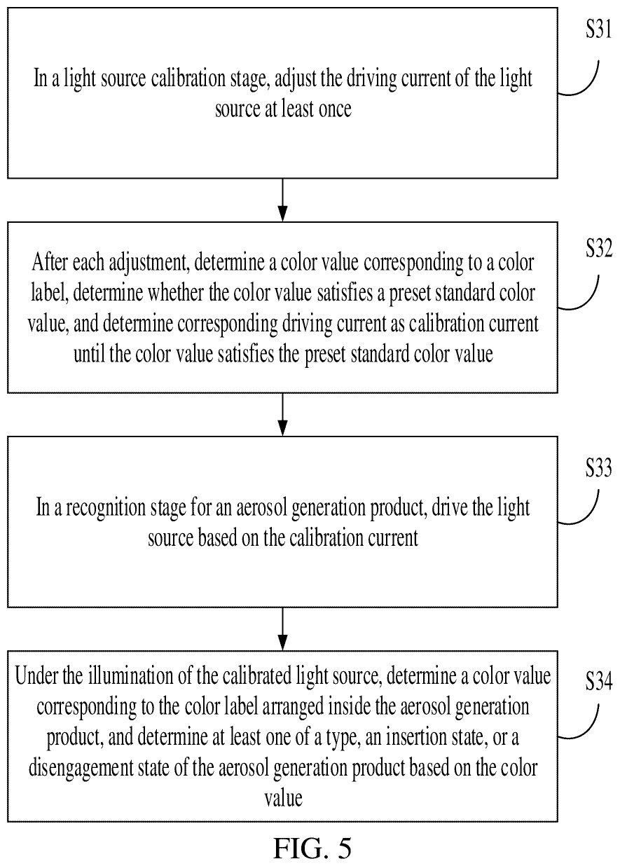

Referring to FIG. 4, FIG. 4 is a flowchart of a control method for an aerosol generation apparatus according to an embodiment of the present application. The aerosol generation apparatus includes an aerosol generation heating element, a light source, and a color sensor; and the color sensor is configured to detect a color value of a color label in a case that the light source provides illumination. As shown in FIG. 4, the control method for the aerosol generation apparatus includes: S21. Initiate a light source calibration stage based on at least one of the following conditions: each time a user turns on the light source, reaching a preset number of instances of turning on, and reaching preset working duration of the light source.

For example: that the light source calibration stage is initiated at each time a user turns on the light source means that the light source calibration stage will be initiated when the user turns on the light source for the 20th time, and the light source calibration stage will be initiated when the user turns on the light source for the 21st time. That the light source calibration stage is initiated when a number of instances of turning on reaches the preset number of instances of turning on means that if the preset number of instances of turning on of the aerosol generation apparatus is 10, the light source calibration stage will be initiated when the number of instances of turning on reaches 10. That the light source calibration stage is initiated when working duration of the light source reaches the preset working duration of the light source means that the light source calibration stage will be initiated if the preset working duration of the light source is 60 minutes. Light source calibration may be performed first when the light source is turned on at next time.

S22. In the light source calibration stage, output initial driving current.

Specifically, the initial driving current is output based on preset initial driving current or based on driving current obtained after calibration current determined in a previous light source calibration stage changes based on a preset increment rule. The processor stores a magnitude of the preset initial driving current and the preset increment rule of change of the initial driving current. After the light source calibration stage is initiated, the processor transmits a control signal to the constant-current driver chip based on the stored magnitude of the preset initial driving current or the preset increment rule of the change of the initial driving current. The control signal includes a clock signal and a data signal, and the constant-current driver chip outputs the initial driving current based on the clock signal and the data signal.

For example: the initial driving current output by the aerosol generation apparatus in the light source calibration stage is preset initial driving current. When the preset initial driving current is 20 mA, initial driving current of 20 mA is output at each time the light source calibration stage is initiated. In the light source calibration stage, the aerosol generation apparatus outputs the initial driving current based on the driving current obtained after the calibration current determined in the previous light source calibration stage changes based on the preset increment rule. When the preset increment rule is that the initial driving current output in each light source calibration stage is increased by 0.1 mA based on the calibration current determined in the previous light source calibration stage, if the calibration current determined in the previous light source calibration stage is 20.5 mA, the initial driving current output in a current light source calibration stage is 20.6 mA, and the initial driving current output in a next light source calibration stage is 20.7 A.

S23. Drive the light source based on the initial driving current, and determine a color value corresponding to the color label under the illumination of the light source, where the color label is arranged inside a calibration fixture and/or an aerosol generation product.

The calibration fixture is a tool specifically configured to calibrating the light source in the recognition process, and the color label is arranged on the calibration fixture. The calibration fixture may alternatively calibrate the light source through the aerosol generation product. When the color label is arranged inside the aerosol generation product or the calibration fixture, n output ends of the constant-current driver chip simultaneously output n constant currents to respectively drive n LEDs in the light source. The color sensor performs color recognition on the color label arranged in the aerosol generation product or the calibration fixture under a condition that the n LEDs are lit, and obtains a corresponding color value.

For example: when n is 3, that is, when the light source specifically includes three LEDs, as shown in FIG. 2, the eleventh end, the twelfth end, and the thirteenth end of the constant-current driver chip simultaneously output constant currents to control the light source. Specifically, the constant current output by the eleventh end of the constant-current driver chip drives the LED5. The constant current output by the twelfth end of the constant-current driver chip drives the LED1. The constant current output by the thirteenth end of the constant-current driver chip drives the LED2. The color sensor recognizes the color label arranged in the aerosol generation product under the action of joint illumination of the LED1, the LED2, and the LED5 and obtains a color value corresponding to the color label. It can be understood that the color label has a color itself. The finally obtained color value is a color value obtained by combining the color of the color label and the light source.

S24. If the color value satisfies a preset standard color value, determine the initial driving current as calibration current.

For example: the preset standard color value is (255, 255, 0). When the color sensor recognizes that the color value corresponding to the color label is exactly (255, 255, 0), the initial driving current is the calibration current, and the processor saves the magnitude of the initial driving current as the calibration current. In this case, the light source calibration stage ends.

S25. In a recognition stage for the aerosol generation product, drive the light source based on the calibration current, and determine a color value corresponding to the color label under the illumination of the light source, where the color label is arranged inside the aerosol generation product inserted into the aerosol generation apparatus.

The processor outputs a control signal to the constant-current driver chip of the light source driving circuit based on the saved calibration current. The constant-current driver chip outputs constant driving current based on the control signal to drive the LEDs in the light source. The color sensor recognizes the color label arranged in the aerosol generation product under the illumination of the light source and obtains the color value corresponding to the color label.

S26. Determine at least one of a type, an insertion state, or a disengagement state of the aerosol generation product based on the color value.

In some embodiments, when a user needs to inhale and inserts an aerosol generation product into the aerosol generation apparatus, light emitted by the light source may illuminate the color label of the aerosol generation product. The processor may control the color sensor to detect a color value of the color label. If the detected color value satisfies the preset standard color value or a standard color range, it can be determined that the aerosol generation product has been inserted. The processor turns on a heating element to work based on the insertion.

In some embodiments, there are aerosol generation products with different flavors for selection by a user, and different color labels are set to distinguish the types of the aerosol generation products. For example: Green represents a mango-flavored aerosol generation product; and blue represents a coffee-flavored aerosol generation product. If the color sensor recognizes the color label and obtains a corresponding color value of (0, 255, 0), the aerosol generation product has a mango flavor. When a user needs to inhale and inserts an aerosol generation product into the aerosol generation apparatus, light emitted by the light source may illuminate the color label of the aerosol generation product. The processor may control the color sensor to detect a color value of the color label. If a corresponding color value is obtained, the processor may determine the type of the aerosol generation product. For example, if the detected color value is (0, 0, 255), it can be determined that the aerosol generation product has a coffee flavor. The processor may drive the heating element based on the insertion event and a corresponding heating mode or prompt an insertion type through an interaction interface.

In some embodiments, in the process of driving the aerosol heating element by the processor, the light source is continuously turned on, and the color sensor continuously detects a color value of the color label. If the detected color value changes, or if the standard color value is not detected, or if the detected color value is not within the standard color range, it can be determined that the aerosol generation product has been pulled out of the aerosol generation apparatus. The processor may stop driving the heating element based on the pulling event.

In some embodiments, when a user needs to inhale and inserts an aerosol generation product into the aerosol generation apparatus, light emitted by the light source may illuminate the color label of the aerosol generation product. The processor may control the color sensor to detect a color value of the color label. If the detected color value satisfies a preset standard color value or a standard color range of one aerosol generation product, it can be determined that a particular type of aerosol generation product has been inserted. The processor may drive the heating element based on the insertion event and a corresponding heating mode.

In some embodiments, when a user needs to inhale and inserts an aerosol generation product into the aerosol generation apparatus, light emitted by the light source may illuminate the color label of the aerosol generation product. The processor may control the color sensor to detect a color value of the color label. If the detected color value satisfies the preset standard color value or is within a standard color range, it can be determined that the aerosol generation product has been inserted. Meanwhile, in the process of driving for heating, the light source is continuously turned on, and the color sensor continuously detects a color value of the color label. If the detected color value changes, or if the standard color value is not detected, or if the detected color value is not within the standard color range, it can be determined that the aerosol generation product has been pulled out of the aerosol generation apparatus. The processor may turn on the heating element to work based on the insertion event and stop driving the heating element based on the pulling event.

In this embodiment of the present application, the initial driving current is output in the light source calibration stage. If the color value detected by the color sensor is the preset standard color value, the initial driving current is determined as the calibration current, and the light source is calibrated based on the calibration current. The color sensor performs product recognition under the calibrated light source condition, which solves the problem of inaccurate recognition caused by instability and inconsistency of the light sources and improves the accuracy of product color recognition.

Referring to FIG. 5, FIG. 5 is another flowchart of a control method for an aerosol generation apparatus according to an embodiment of the present application. The aerosol generation apparatus includes an aerosol generation heating element, a light source, and a color sensor; and the color sensor is configured to detect a color value of a color label in a case that the light source provides illumination. A light source calibration stage is initiated based on at least one of the following conditions: each time a user turns on the light source, reaching a preset number of instances of turning on, and reaching preset working duration of the light source. As shown in FIG. 5, the control method for the aerosol generation apparatus includes:

S31. In a light source calibration stage, adjust the driving current of the light source at least once.

In the light source calibration stage, in a case that the light source attenuates, the light source provides illumination under driving of initial driving current. A color value obtained by recognizing the color label by the color sensor may not be a preset standard color value. A processor needs to output a control signal to a constant-current driver chip to adjust the driving current of the light source. For example: In the light source calibration stage, the color sensor recognizes the color label and obtains a color value of (153, 51, 250). The processor compares this color value with a preset standard color value of (160, 32, 240) stored in the processor. If the two color values are significantly different or if the color value has exceeded a preset standard color range, the processor needs to transmit a control signal to the constant-current driver chip to adjust the driving current of the light source and initiate a next color recognition process, and may not adjust the driving current of the light source until the color value obtained by recognizing the color label by the color sensor satisfies the preset standard color value. Then, the light source calibration stage ends.

S32. After each adjustment, determine a color value corresponding to the color label, determine whether the color value satisfies a preset standard color value, and determine corresponding driving current as calibration current until the color value satisfies the preset standard color value.

Specifically, after the processor performs each adjustment on the driving current of the light source, the color sensor needs to recognize the color label and obtains a current color value. The current color value is compared with the preset standard color value. If the current color value is not the preset standard color value, step S31 is performed to continue to adjust the driving current of the light source. If the current color value is consistent with the preset standard color value or is within a preset standard color range, the corresponding driving current is determined as the calibration current. The processor saves a magnitude of the calibration current. In this case, the light source calibration stage ends.

S33. In a recognition stage for an aerosol generation product, drive the light source based on the calibration current.

The processor outputs a control signal to a constant-current driver chip of a light source driving circuit based on the saved calibration current. The constant-current driver chip outputs constant driving current based on the control signal to drive LEDs in the light source.

S34. Under the illumination of the calibrated light source, determine a color value corresponding to the color label arranged inside the aerosol generation product, and determine at least one of a type, an insertion state, or a disengagement state of the aerosol generation product based on the color value. The control principle of step S34 is the same as the control principle of step S26. Refer to step S26 for specific details.

In this embodiment of the present application, steps for calibrating the light source are added in the application process of the color sensor. The color value of the color label detected by the color sensor is compared with the preset standard color value, to output the control signal to continuously adjust the driving current of the light source. When the detected color value is the preset standard color value, the driving current of the light source is determined as the calibration current, and the light source is driven based on the calibration current, to calibrate the light source. The color sensor performs product recognition under the calibrated light source condition, which solves the problem of inaccurate recognition caused by instability and inconsistency of the light sources and improves the accuracy of product color recognition.

It should be finally noted that: the foregoing embodiments are merely used for describing the technical solutions of the present application, but are not intended to limit the present application. Under the ideas of the present application, the technical features in the foregoing embodiments or different embodiments may alternatively be combined, the steps may be performed in any order, and many other changes of different aspects of the present application also exists as described above, and these changes are not provided in detail for simplicity. Although the present application is described in detail with reference to the foregoing embodiments, it should be appreciated by a person skilled in the art that, modifications may still be made to the technical solutions described in the various foregoing embodiments, or equivalent replacements may be made to a part of the technical features; and these modifications or replacements will not cause the essence of the corresponding technical solutions to depart from the scope of the technical solutions in the various embodiments of the present application.

1. An aerosol generation apparatus, comprising:
an aerosol heating element, configured to heat an aerosol generation product to generate an aerosol;
a color sensor, configured to detect a color value of a color label;
a light source, configured to provide illumination during detection of the color label by the color sensor;
a power supply; and
a processor, configured to: in a light source calibration stage, adjust driving current of the light source, determine a color value corresponding to the color label under the illumination of the light source that is subjected to each adjustment, and determine corresponding driving current as calibration current until the color value satisfies a preset standard color value, wherein the color label is arranged inside a calibration fixture and/or the aerosol generation product,
the processor being further configured to: in a recognition stage for the aerosol generation product, drive the light source based on the calibration current; determine, under the illumination of the light source, a color value corresponding to the color label arranged inside the aerosol generation product; and determine at least one of a type, an insertion state, or a disengagement state of the aerosol generation product based on the color value, wherein the color label is arranged inside the aerosol generation product.

2. The aerosol generation apparatus according to claim 1, further comprising a light source driving circuit, wherein the light source driving circuit comprises a constant-current driver chip, and the constant-current driver chip is respectively connected to the light source, the power supply, and the processor; and
the constant-current driver chip is configured to: adjust, based on a control signal output by the processor, the driving current and output the driving current to the light source.

3. The aerosol generation apparatus according to claim 2, wherein the light source comprises at least two light-emitting diodes (LEDs).

4. The aerosol generation apparatus according to claim 3, wherein the constant-current driver chip comprises a clock signal input end and a data signal input end; and the clock signal input end and the data signal input end are configured to receive the control signal transmitted by the processor through an inter-integrated circuit (IIC) bus, to control the driving current output by the constant-current driver chip.

5. The aerosol generation apparatus according to claim 4, wherein the constant-current driver chip further comprises at least two driving current output ends, and the at least two driving current output ends are respectively connected to the at least two LEDs to drive the at least two LEDs.

6. A control method for an aerosol generation apparatus, wherein the aerosol generation apparatus comprises an aerosol heating element, a light source, and a color sensor; the color sensor is configured to detect a color value of a color label in a case that the light source provides illumination; and
the method comprises:
in a light source calibration stage, outputting initial driving current;
driving the light source based on the initial driving current, and determining a color value corresponding to the color label under the illumination of the light source, wherein the color label is arranged inside a calibration fixture or an aerosol generation product;
if the color value satisfies a preset standard color value, determining the initial driving current as calibration current;
in a recognition stage for the aerosol generation product, driving the light source based on the calibration current, and determining a color value corresponding to the color label under the illumination of the light source, wherein the color label is arranged inside the aerosol generation product inserted into the aerosol generation apparatus; and
determining at least one of a type, an insertion state, or a disengagement state of the aerosol generation product based on the color value.

7. The control method according to claim 6, wherein in the light source calibration stage, the method further comprises:
if the color value does not satisfy the preset standard color value, adjusting the initial driving current at least once; and
driving the light source based on the adjusted driving current, determining a color value corresponding to the color label under the illumination of the light source, and determining the last adjusted driving current as the calibration current until the color value satisfies the preset standard color value.

8. The control method according to claim 6, wherein before the light source calibration stage, the method includes:
initiating the light source calibration stage based on at least one of the following conditions: each time a user turns on the light source, reaching a preset number of instances of turning on, and reaching preset working duration of the light source.

9. The control method according to claim 6, wherein in the light source calibration stage, the outputting initial driving current comprises:
outputting the initial driving current based on preset initial driving current or based on driving current obtained after calibration current determined in a previous light source calibration stage changes based on a preset increment rule.

10. A control method for an aerosol generation apparatus, wherein the aerosol generation apparatus comprises an aerosol generation heating element, a light source, and a color sensor; the color sensor is configured to detect a color value of a color label in a case that the light source provides illumination; and
the method comprises:
in a light source calibration stage, adjusting the driving current of the light source at least once;
after each adjustment, determining a color value corresponding to the color label, determining whether the color value satisfies a preset standard color value, and determining corresponding driving current as calibration current until the color value satisfies the preset standard color value;
in a recognition stage for an aerosol generation product, driving the light source based on the calibration current; and
under the illumination of the calibrated light source, determining a color value corresponding to the color label arranged inside the aerosol generation product, and determining at least one of a type, an insertion state, or a disengagement state of the aerosol generation product based on the color value.
